(19) United States
(12) Patent Application Publication
(10) Pub. No.: US 2008/0119295 A1
(43) Pub. Date: May 22, 2008

(54) Compact hub unit featuring assymmetrical bearings and constant velocity joint outer race

(76) Inventor: Frank Victor Csik, Beaconsfield (CA)

Correspondence Address: FRANK VICTOR CSIK, 421 CHURCH STREET, BEACONSFIELD, QC, H9W 3R7, omitted

(21) Appl. No.: 11/984,358

(22) Filed: Nov. 16, 2007

Related U.S. Application Data
(60) Provisional application No. 60/859,588, filed on Nov. 20, 2006.

(51) Int. Cl. F16D 3/20

(52) U.S. Cl. 464/145

(57) ABSTRACT

In a wheel hub module for motorized land vehicles, there is provided an arrangement comprising a hub module casing member, a hub subassembly composed of permanently joined pre-loaded co-rotating inboard and outboard members, inboard and outboard complements of bearing rolling elements and a constant velocity joint wherein the CV joint's outer race proper is the inboard wheel bearing's inner race, and wherein the respective inboard and outboard wheel bearing's raceways may be of identical or of mutually different geometric dimensions, and wherein the inboard wheel bearing provides full end support to the CV joint outer race itself, making for a simple, robust and compact hub module.

The present application claims the benefit of the currently pending provisional application having Ser. No. 60/859,588, filed Nov. 20, 2006, and it is requested to convert it into a non-provisional application. It is to be noted that the provisional application's “as submitted” title reading “COMPACT HUB UNIT FEATURING ASSYMMETRICAL BEARINGS AND CONSTANT VELOCITY JOINT OUTER RACE” is herewith requested to be changed to read “COMPACT WHEEL HUB UNIT FEATURING AN INTEGRATED CONSTANT VELOCITY JOINT OUTER RACE” in order to distance itself from similarly titled existing in-force patents.

### FIELD OF THE INVENTION

The present invention relates to improvements in a driven wheel's unitary hub module comprising inseparably interconnected module components by way of substituting a constant velocity joint (CVJ) outer race member for the inboard bearing's inner race member, and the method of its integration into the hub module.

In this invention the term “constant velocity joint outer race proper” is intended to be limiting to the extent that it shall denote only the generally bell shaped part of the outer race which contains the ball grooves inside its cavity for transmitting driving torque from the inner race of the joint, which inner race is non-rotatably connected to the drive axle stub shaft. The term “constant velocity joint's outer race proper” shall specifically exclude any appendage, whether of reduced diameter or not, which may form an integral part of the outer CVJ race member for the purpose of affixing it to the hub outboard member. Further, the term “driven plane” refers the plane being normal to the outer race's rotational axis and in line with the flexural center of the CVJ. The term “flexural center” refers to that point, which lies at the intersection of the joint's driving and driven axes, otherwise know as joint center. The terms “inboard” and “outboard” refer to the ends of the hub assembly being respectively closer to and/or farther from the vehicle's longitudinal center plane.

### BACKGROUND TO THE INVENTION

While numerous types of driven wheel hub concepts have been devised, not one has demonstrably combined simplicity, robustness and desirable geometry in the same package.

Some have combined simplicity and robustness (e.g., the SKF Hub for Motorized Land Vehicles, commonly known as the “X-Tracker”), and others managed to combine compactness and close-to-desirable geometry (e.g., FAG U.S. Pat. No. 4,986,607), none have combined robustness with simplicity and compactness, which the embodiment herein discloses.

To reflect upon this invention's primary advantage, this packaging concept makes negative scrub radius with low kingpin angle easily achievable, even on heavy vehicles such as SUVs and light trucks, because the wheel-end CV joint's flexural center can be positioned nearer to the wheel center plane than with any other hub design concept, while at the same time the CV joint's outer race is fully supported by the inboard bearing's rolling elements, as opposed to being cantilevered as per normal practice. In normal practice the CV joint is cantilevered by virtue of the CVJ proper being an addition to the hub module rather than being integral part thereof, and thus by being inboard of the hub, forcing the CV joint's flexural center to be considerably inboard of the ideal location, which in turn forces the kingpin axis too far inboard as well, making negative scrub radius hard to achieve at best, or not at all.

### SUMMARY OF THE INVENTION

The objective of the present invention is to provide a simple, compact and robust cartridge type of hub module assembly for wheel support in a land vehicle, and that objective is achieved with a permanently interconnected arrangement comprising a driven wheel's hub composed of form-fittingly joined co-rotating inboard and outboard members, a generally cylindrical outer casing member, a pair of axially spaced apart inboard and outboard wheel bearings occupying the annular space between said hub and said outer casing members, wherein each of said inboard and said outboard bearing rows is comprised of a plurality of rolling elements being suitable for supporting combined axial and radial loads and further, wherein said hub subassembly's said inboard member is a CV joint outer race proper, and whereof said form fitting means of interconnecting mechanism enables the bearings to be in a preloaded union with their respective inner and outer raceways.

Further, owing to the fact that the inboard and outboard bearings are independent of one another, the shape geometry and sizes of their respective rolling elements can be optimized and their respective raceway diameters can be mutually independently sized and further, since they can be axially separated sufficiently far apart, potential axle wobble is greatly reduced, thus control of the wheel's orientation is greatly improved in the presence of applied lateral loads at the wheel/road interface, and the increased mechanical advantages accorded thereto not only lead to reduced bearing stresses, but with steering lock application the bending moments resulting from the application of driving torque in the CVJ are greatly reduced, as full end support is accorded to the CV joint's outer race proper.

According to one aspect of the invention, there is provided an interconnecting arrangement for a cartridge type of vehicle axle hub module comprising a generally cylindrical outer casing member with a mounting flange, an interconnected co-axial and co-rotating hub sub-assembly comprised of an outboard and an inboard member with respective inner raceways thereon, wherein said inboard member is defined by a CV joint outer race member having an a shoulder adjacent to and outboard of said raceway thereon for confronting a corresponding planar surface of said outboard member, a form-fitting coaxial generally cylindrical stub axle extending outwardly from said hubs' said inboard member, and a flanged outboard hub member having a generally cylindrical main body with a concentric generally cylindrical through-bore originating on the inboard planar surface thereof and a counterbore at its inboard end therein, inboard and outboard wheel bearings each having a plurality of rolling elements and inboard and outboard bearing seals, wherein said interconnected hub sub-assembly, said inboard and outboard wheel bearings and said seals are arranged on mutually coaxial axes, and wherein said hub sub-assembly is being rotatably supported within said outer casing member by said wheel bearings and said hub flange is having provisions for mounting a road wheel thereto, the arrangement comprising a mechanism for rotatably mounting a road wheel into a suspension upright.

In this arrangement the hub's inboard and outboard members are made of induction hardenable or case-hardenable steel alloy, such that surfaces thereof may be selectively hardened independently of their core hardness. Further, said hub's said integral outwardly extending coaxial cylindrical stub axle is provided with a first set of radially disposed axially oriented pointed teeth thereon and a generally cylindrical counterbore at its outboard end therein. At the time of inseparably joining said inboard member's said stub axle into said outer member's bore and counterbore, as said stub axle is being axially forced into said bore of said outer member until said stub axle's said shoulder confronts the outer member's said inboard planar surface, the previously hardened said first set of teeth displace material from said outer member's said bore towards the its outboard end, forming a first set of corresponding teeth therein, and causing a portion of said stub axle to protrude through said outboard member's outboard end. The joining operation is completed by outwardly deforming said stub axle's said protruding portion, thus forming a collar upended tightly against said outboard member's outer end, creating an inseparable assembly therewith.

According to an alternate concept, the stub axle extending outwardly from the hub inboard member's outer race proper may be a mechanically integrated discrete segment thereof, so as to permit cost efficient use of mutually exclusive alloys for said axle and said outer race proper, wherein said outer race proper made of rolling contact bearing steel is being provided with a concentric cylindrical bore originating on the outboard planar surface thereof and terminating at the inboard planar surface being within the cage cavity therein, and wherein said stub axle made of induction hardenable or case-hardenable steel is being provided with an inwardly extending concentric annular root, said root originating at the planar inboard end of said stub axle forming an abutting shoulder thereof, wherein said root is provided with a second set of radially disposed axially oriented pointed teeth thereon and a cylindrical counterbore therein. At the time of inseparably joining said stub axle to said CV joint's outer race proper, as said root is being axially forced into said bore of said outer race proper until said root's said shoulder confronts the outer race's said outboard planar surface, the previously hardened said second set of teeth displace material from said outer race's said bore towards the cage cavity, forming a second set of corresponding teeth therein, and causing a portion of said root protruding into said cage cavity therein. The joining operation is completed by outwardly deforming said root's said protruding portion, thus forming a collar abutting said inboard planar surface therein, creating an inseparable assembly thereof. The stub axle's outwardly extending portion is the same as that described in the previous paragraph.

In one embodiment there is provided an arrangement wherein the inboard and outboard integral annular outer raceway surfaces inside the cartridge casing, and the integral annular inner raceway surfaces on the CV joint and the flanged hub respectively are in bearing contact with their respective compliments of rolling elements, and wherein said inboard and outboard plurality of rolling element sets are ensconced in their respective cages, and wherein the CV joint's integral coaxial outwardly extending stub axle and the generally cylindrical bore of the flanged hub outboard member form-fittingly and non-rotatably engage one another in a permanently pre-tensioned manner constituting a single interconnecting arrangement of concentrically and rotatably mounted inboard and outboard pair of bearings in said cartridge casing, said cartridge casing comprising said bearings' outer races by virtue of a pair of axially spaced apart concentric counterbores at opposite ends of said main bore thereof for ensconcing said interconnecting arrangement therein, said outer races of said inboard and outboard bearings facing one another for tensioning said pair of adjustable bearings confronting said means of bearing support therein, and said pair of wheel bearings locating and providing full end support at both ends to said rotating interconnecting arrangement in said cartridge casing.

While the concentric interconnected arrangement of said wheel support assembly may be laid out in any number of ways, in all cases the raceway on said CV joint's outer race proper is being in bearing contact with the plurality of rolling elements of the inner wheel bearing, and wherein said raceway is in the general area occupied by said CV joint's driven plane.

Preferably, the CV joint's outer race proper and the concentric outwardly extending stub axle thereof are made as a homogenous entity.

### BRIEF DESCRIPTION OF THE DRAWINGS

Having thus generally described the invention, reference will be made to the accompanying drawings illustrating embodiments thereof, in which:

FIG. 1 is a side view with a broken out section of the CV joint outer race, noting commonly used terminology occurring throughout this document;

FIG. 2 is a side view with a broken out section of one arrangement of the CV joint outer race;

FIG. 3 is a side view with a broken out section of an alternate arrangement of the CV joint outer race;

FIG. 4 is a cutaway view of one embodiment of an interconnecting arrangement for a vehicle driven wheel hub module and hub drive mechanism;

FIG. 5 is a cutaway view of a further embodiment of an interconnecting arrangement for a vehicle driven wheel hub module and hub drive mechanism;

FIG. 6 is a cutaway view of a further embodiment of an interconnecting arrangement for a vehicle driven wheel hub module and hub drive mechanism;

FIG. 7 is a cutaway view of a further embodiment of an interconnecting arrangement for a vehicle driven wheel hub module and hub drive mechanism;

### DESCRIPTION OF THE PREFERRED EMBODIMENTS

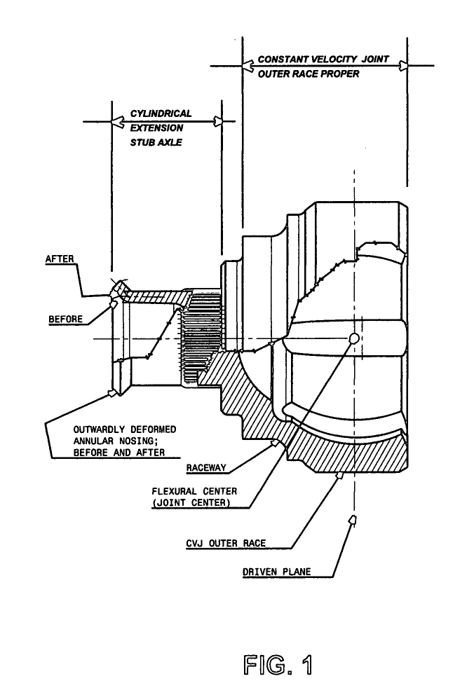

Referring to the drawings in greater detail and by reference characters thereto, in FIG. 1 there is illustrated a side elevation with broken out sectional view of the CV joint's outer race, noting the terminology referring to elements thereof and occurring throughout this document.

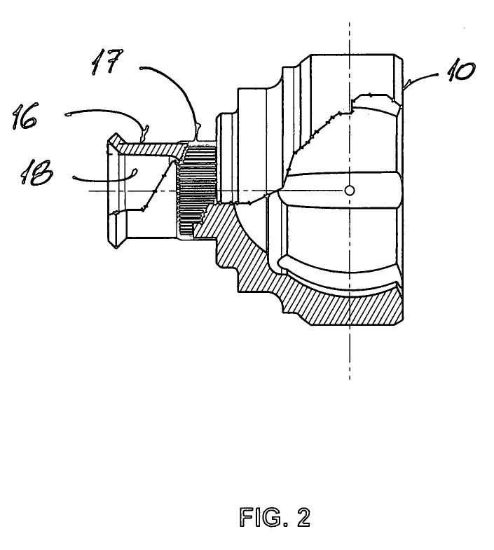

Referring to the drawing in FIG. 2, there is illustrated a side elevation with broken out sectional view of a CV joint's outer race 10 with an integral concentric generally cylindrical outwardly extending stub axle 16.

The CV joint's outer race proper 10 is made of induction hardenable or case hardenable steel, whereof said stub axle 16 around its circumference adjacent to the outer race proper is formed with integral axially oriented radially disposed plurality of pointed teeth 17 and further, wherein there is provided a counterbore 18 at its outboard end.

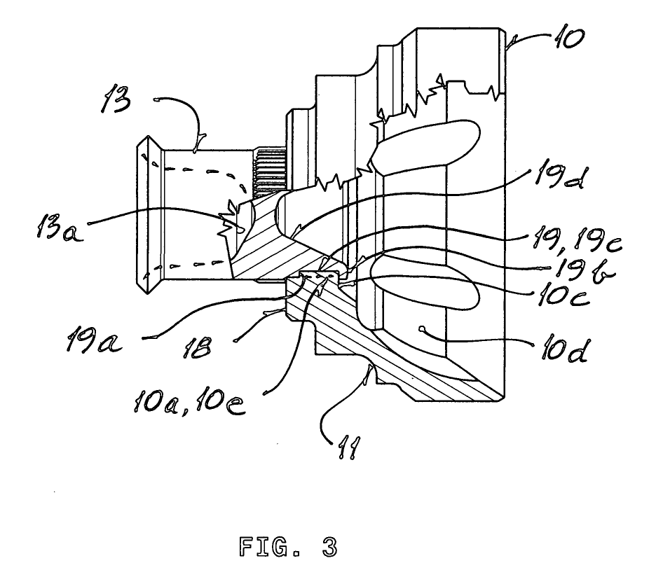

Referring to the drawing in FIG. 3, there is a side elevation with broken out sectional view of an alternate embodiment of a CV joint's outer race 10 illustrating a subassembly comprising said CV joint's outer race proper 10 and a concentric mechanically integrated discrete stub axle 13 extending outwardly therefrom.

The CV joint's outer race proper 10, made of rolling contact bearing steel, is provided with a concentric cylindrical bore 10a originating on the outboard planar surface 18 thereof and terminating at the inboard planar surface 10c being within the cage cavity 10d therein.

Stub axle 13, being made of induction hardenable or case-hardenable steel, is provided with an inwardly extending concentric annular root 19, said root originating at the planar inboard shoulder 19a of stub axle 13, wherein said root 19 is being provided with a first set of radially disposed axially oriented pointed teeth 19c thereon, a first cylindrical counterbore 19d therein at said stub axle's inboard end, and a second cylindrical counterbore 13a at said stub axle's outboard end.

At the time of inseparably joining said stub axle 13 to said CV joint 10 outer race proper, the previously hardened teeth 19c of stub axle's said root 19 are being axially forced into the bore 10a of said outer race proper, said first set of teeth 19c displace material from said outer race's said bore 10a towards the cage cavity 10d, forming a second set of teeth 10e therein, a portion of said root 19 protruding into said cage cavity 10d therein. The uniting force is maintained until shoulder 19a of said root confronts the outer race's said planar surface 18. The joining operation is completed by outwardly deforming said root's said protruding portion 19 causing the creation of a collar 19b abutting said inboard planar surface 10c therein, creating an inseparable assembly therewith.

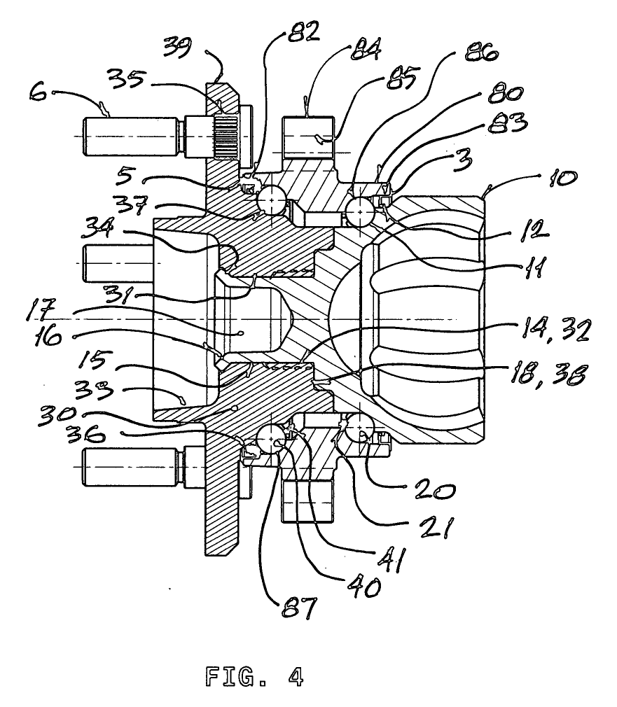

Referring to the drawing in FIG. 4, there is illustrated in sectional view a wheel hub and axle drive mechanism whose inboard and outboard bearing rolling elements 20 and 40 respectively are spherical and their shape geometry and raceway diameters are optimally and mutually independently sized, and whose rows are axially separated, and further, which includes a wheel hub sub-assembly comprised of an inner member defined by a CV joint outer race 10 and outboard member 30, a plurality of inboard rolling elements 20 retained thereto by spacer cage 21, a plurality of outboard rolling elements 40 retained thereto by spacer cage 41, an inboard bearing seal 3, an outboard bearing seal 5, and finally wheel mounting threaded lugs 6 and a hub module outer casing member generally designated by reference numeral 80, said outer casing member having at least one suitable means for securely attaching to a vehicle suspension upright.

The induction hardenable or case-hardenable steel CV joint outer race 10 is configured to include an annular raceway 11 for being in bearing contact with rolling elements 20 being retained thereto by spacer cage 21, a machined journal 12 for bearing seal 3, an integral coaxial outwardly extending stub axle 13, whereof there is provided an outwardly extending concentric annular nosing 16 and a cylindrical counterbore 17 therein.

Hub outboard member 30 includes a concentric bore 31 to mate with the coaxial outwardly extending stub axle 13 and a coaxial outboard counterbore 33 thus creating a face 37 therein, said hub outboard member 30 having coaxial journal seat 31 for mating with corresponding journal surface 15 of said stub axle 13, a face 38 abutting shoulder 18 of said CV joint 10, and a second raised coaxial journal seat 36 for coming into contact with outboard bearing seal 5, and finally a hub flange 39 is provided with bolt holes 35 thereon for securing the threaded wheel mounting lugs 6 therein. Said hub 30 is held securely in position on said CV joint 10 coaxial outwardly extending stub axle 13 by said coaxial annular nosing 16 being deformed into permanent union with said concentric outboard shoulder 34 of said hub 30.

The integral stub axle 13 of CV joint outer race 10 is provided with a concentric cylindrical surface 15 thereon to snugly slide into bore 31 of said hub module outboard member 30 such that said annular nosing 16 protrudes into said outboard member counterbore 33 of said hub outboard member 30, and further, at the inboard end of said stub axle 13 adjacent to said CV joint outer race proper 10, said stub axle 13 is being provided with a first set of circumferentially disposed axially oriented pointed teeth 14 thereon.

The hub module assembly comprises an inboard hub member defined by a CV joint outer race 10, a hub outboard member 30, a hub module outer casing member 80, a plurality of inboard rolling elements 20 with spacer cage 21, a plurality of outboard rolling elements 40 with spacer cage 41, wherein said rolling elements 20 and 40 are in rolling contact with integral inboard 86 and outboard 87 raceways respectively of said outboard casing member 80 and said hub sub-assembly comprised of said outboard member 30 and said inboard member 10 respectively, and wherein said hub module further includes inboard and outboard wheel bearing seals 3 and 5 respectively.

At the time of inseparably joining said CV joint outer race proper 10 to said hub outboard member 30, the previously hardened teeth 14 of said stub axle's said cylindrical surface 15 are being axially forced into the said bore 31 of said hub 30, said first set of teeth 14 displace material from said hub's said bore 31 towards the outboard member counterbore 33, forming a second set of teeth 32 therein, and causing a portion of said annular lip 15 to protrude into said counterbore 33 therein. The uniting force is maintained until shoulder 18 of said CV joint outer race proper 10 abuts said face 38 of said hub 30, at which time said rolling elements and said inner and outer raceways are drawn to one another with a predetermined level of load. The joining operation is completed by outwardly deforming said protruding portion of said annular nosing 16 causing the creation of a collar 16 confronting said outboard face 31a therein, creating an inseparable assembly thereof.

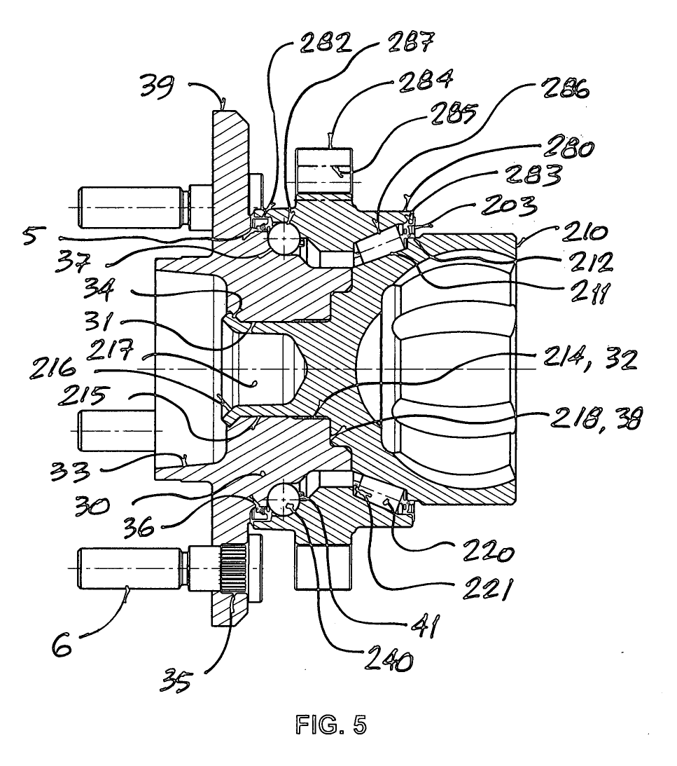

Referring to the drawing of the first alternate configuration as illustrated in FIG. 5, similar reference numerals in the 200's are used for similar components, and the same reference numerals are used for identical components. The wheel hub and axle drive mechanism shown in FIG. 5 is essentially the same as that of the first embodiment, the exception being in the details of the inboard wheel bearing arrangement, wherein said bearing's inboard rolling elements 220 are tapered rollers.

Closer look at FIG. 5 reveals a CV joint outer race 210 configured to include an conical raceway 211 being in bearing contact with tapered roller elements 220, a spacer cage 221 retaining said rolling elements thereto, a machined journal 212 being in sliding contact with seal 203, and an integral coaxial outwardly extending stub axle 213 having an outwardly extending concentric annular nosing 215 and a cylindrical counterbore 217 at its outboard end thereof. And further, outer casing member 280 is configured to include a conical inboard outer raceway 286 to be in bearing contact with rolling elements 220 and journal surface 283 to receive inboard bearing seal 203.

In all other respects, the concept shown in FIG. 5 is identical to that shown in FIG. 4.

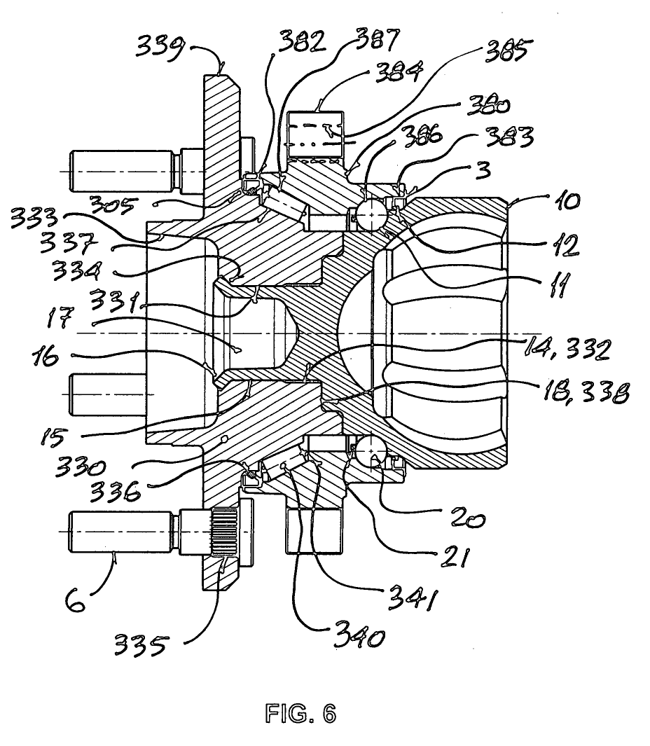

Referring to the drawing of the second alternate configuration as illustrated in FIG. 6, similar reference numerals in the 300's are used for similar components, and the same reference numerals are used for identical components. The wheel hub and axle drive mechanism shown in FIG. 6 is essentially the same as that of the first embodiment, the exception being in the details of the outboard wheel bearing arrangement, wherein said bearing's outboard rolling elements 340 are tapered rollers.

Closer look at FIG. 6 reveals a hub outer member 330 configured to include an conical raceway 337 being in bearing contact with tapered roller elements 340, a spacer cage 341 retaining said rolling elements thereto, a machined journal 336 being in sliding contact with seal 305, and a concentric annular bore 331 at its center. And further, outer casing member 380 is configured to include a conical outboard outer raceway 387 to be in bearing contact with rolling elements 340 and journal surface 382 to receive inboard bearing seal 305.

In all other respects, the concept shown in FIG. 6 is identical to that shown in FIG. 4.

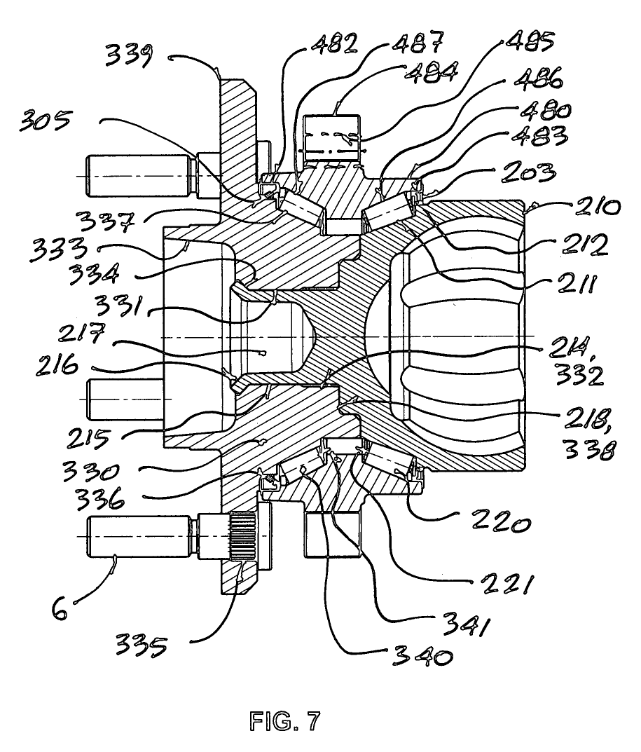

Referring to the drawing of the third alternate configuration as illustrated in FIG. 7, similar reference numerals in the 400's are used for similar components, and the same reference numerals already listed in the application of identical components of previously described iterations in FIGS. 5 and 6 are used for identical components. The wheel hub and axle drive mechanism shown in FIG. 7 is essentially the same as that of the first embodiment, the exception being in the details of the inboard and outboard wheel bearing arrangement, wherein said bearing's inboard and outboard rolling elements are tapered rollers.

Closer look at FIG. 7 reveals a hub module assembly comprises an inboard hub member defined by a CV joint outer race 210, a hub outboard member 330, a hub module outer casing member 480, a plurality of inboard rolling elements 220 with spacer cage 221, a plurality of outboard rolling elements 340 with spacer cage 341, wherein said rolling elements 220 and 340 are in rolling contact with integral inboard raceway 486 and outboard raceway 487 respectively of said outboard casing member 480 and said hub sub-assembly comprised of said outboard member 330 and said inboard member 210 respectively, and wherein said hub module further includes inboard and outboard wheel bearing seals 203 and 305 respectively.

In all other respects, the concept shown in FIG. 7 is identical to that shown in FIG. 4.

It will be understood that the above-described embodiments are for purpose of illustration only and that changes and modifications may be made thereto without departing from the spirit and scope of the invention.

I claim:

1. A wheel bearing module comprising a hub composed of an inseparable co-axially arranged co-rotating sub-assembly consisting of inboard and outboard members having respective concentric annular raceways thereon and a radially disposed peripheral flange at its outboard axial end for mounting a road wheel thereto, an outer casing member having a laterally oriented generally cylindrical through-bore cavity therein featuring two discrete co-axially aligned outer raceways at its inboard and outboard ends respectively, a pair of bearings defined by respective rows of pluralities of rolling elements, said rolling elements arranged in pre-loaded rolling contact with their respective annular raceways in said cavity and on said hub.

2. A wheel bearing module as claimed in claim 1, wherein said inboard member of said hub sub-assembly is defined by a constant velocity universal joint's outer race member.

3. A wheel bearing module as claimed in claim 1, wherein said inboard hub member is having an inboard raceway thereon, and wherein said outboard hub member is having an outboard raceway thereon.

4. A wheel bearing module as claimed in claim 1, wherein said inboard and said outboard rolling elements' raceways are of the same geometric dimensions.

5. A wheel bearing module as claimed in claim 1, wherein said inboard and said outboard rolling elements' raceways are of mutually different geometric dimensions.

6. A wheel bearing module as claimed in claim 1, wherein said inboard and said outboard rolling elements are of the same geometric shape and of the same geometric dimensions.

7. A wheel bearing module as claimed in claim 1, wherein said inboard and said outboard rolling elements are of the same geometric shape and of mutually different geometric dimensions.

8. A wheel bearing module as claimed in claim 1, wherein said inboard and said outboard rolling elements are of mutually different geometric shapes.

9. A wheel bearing module as claimed in claim 1, wherein the inboard hub member is defined by a CV joint outer race member having an external annular raceway thereon providing full end support thereto and a partially deformable coaxial stub axle extending outwardly therefrom.

10. A wheel bearing module as claimed in claim 1, wherein the stub axle is discrete member configured to have deformable extremities whose function is to co-rotatingly and inseparably interconnect the inboard and outboard hub members.
